(19) United States
(12) Patent Application Publication
(10) Pub. No.: US 2022/0398548 A1
(43) Pub. Date: Dec. 15, 2022

(54) SYSTEM FOR SCHEDULING AND PERFORMING MAINTENANCE AND/OR REPAIR ON ELECTRICAL EQUIPMENT AND A METHOD OF USING SAME

(71) Applicants: Corey E. Teeple, Lake Ariel, PA (US); Michael P. Wademan, Clarks Summit, PA (US)

(72) Inventors: Corey E. Teeple, Lake Ariel, PA (US); Michael P. Wademan, Clarks Summit, PA (US)

(21) Appl. No.: 17/347,711

(22) Filed: Jun. 15, 2021

(51) Int. Cl. G06Q 10/00; G06K 7/14; G06Q 10/10; G05B 23/02; G06F 16/53; G06F 3/14

(52) U.S. Cl. CPC G06Q 10/20; G06K 7/1417; G06Q 10/105; G05B 23/0283; G06F 16/53; G06F 3/14; G06K 2007/10504

(57) ABSTRACT

The present invention is related to a system and method for scheduling and performing maintenance and/or repair on electrical equipment such as electrical panels, electrical outlets, electrical devices and the like. More particularly, the present invention relates to a system and method that allows a building supervisor/owner and/or an electrical maintenance provider to schedule what electrical equipment will be maintained and/or repaired and when that maintenance and/or repair will be conducted. The present invention will then provide a system and method to allow the electrical maintenance/repair provider to perform the maintenance and/or repair on the desired electrical equipment and provide immediate and up-to-date feedback to the system that the required maintenance and/or repair has been completed.

### FIELD OF THE INVENTION

The present invention is generally related to a system and method for scheduling and performing maintenance and/or repair on electrical equipment such as electrical panels, electrical outlets, electrical devices and the like. More particularly, the present invention relates to a system and method that allows a building supervisor/owner and/or an electrical maintenance provider to schedule what electrical equipment will be maintained and/or repaired and when that maintenance and/or repair will be conducted. The present invention will then provide a system and method to allow the electrical maintenance/repair provider to perform the maintenance and/or repair on the desired electrical equipment and provide immediate and up-to-date feedback to the system that the required maintenance and/or repair has been completed.

### BACKGROUND OF THE INVENTION

It is known that electrical equipment such as electrical panels, electrical outlets, electrical devices (such as elevators, escalators, doors, etc.), and the like need to have regular maintenance in order to function properly. It is also known that electrical equipment can also stop working for a variety of reasons and, consequently, needs to be repaired. In either event, if the electrical equipment needs maintenance or the electrical equipment needs to be repaired because it has stopped working, an electrical maintenance provider will need to know when the maintenance and/or repair will need to be performed.

Currently, it is known that maintenance on electrical equipment can be scheduled at regular intervals such as annually. In this manner, the electrical maintenance provider can routinely schedule a time and date for the electrical maintenance provider to conduct the regularly scheduled maintenance. However, if the electrical equipment unexpectedly stops working, the electrical maintenance provider may have to adjust the electrical equipment maintenance schedule in order to repair the electrical equipment that has unexpectedly stopped working.

It is further known that in order to perform the regularly scheduled maintenance or repair the electrical equipment that has unexpectedly stopped working, one of the required tasks to be performed by the electrical maintenance provider is to shut-off or turn-off any electricity being supplied to the electrical equipment that is being maintained or repaired. Typically, this is accomplished by shutting off or turning off the electrical sub-panel that directly connects the electrical equipment to a source of electricity. Furthermore, if the electrical sub-panel that is electrically connected to the electrical equipment is also electrically connected to an electrical distribution panel, that electrical distribution panel must also be shut down or turned off to further ensure that no electricity will flow to the electrical equipment while the electrical equipment is being maintained or repaired.

However, it is often very time consuming to determine which electrical sub-panel and electrical distribution panel are electrically connected to a particular piece of electrical equipment. Usually, the electrical maintenance provider has to rely on common knowledge about what electrical panels are electrically connected to a particular piece of electrical equipment or the electrical maintenance provider must consult very detailed electrical diagrams that show the electrical connections between a piece of electrical equipment, the sub-panel, and the electrical distribution panel.

Furthermore, once the maintenance or the repair on the electrical equipment has been completed, it is desirable to be able to log the maintenance or repair into a database so that the supervisor or owner and/or the electrical maintenance provider can properly determine when the next regularly maintenance on the piece of electrical equipment should be conducted or to keep track of the repairs to the particular piece of electrical equipment. In particular, it is desired that once the maintenance or the repair on the electrical equipment has been completed, the electrical service technician that performed the maintenance or repair would be able to enter up-to date information about the maintenance or repair into a database so that the maintenance and/or repair information about a particular piece of electrical equipment would be immediately available to the supervisor or owner and/or an electrical maintenance provider so that the supervisor or owner and/or an electrical maintenance provider could see that the maintenance or repair has been completed.

It is a purpose of this invention to fulfill these and other needs in the art of scheduling and performing maintenance and/or repair on electrical equipment in a manner more apparent to the skilled artisan once given the following disclosure.

The preferred system and method for scheduling and performing maintenance and/or repair on electrical equipment, according to various embodiments of the present invention, offers the following advantages: ease of use; decreased time to schedule maintenance or repair of the electrical equipment; decreased time to perform the maintenance or repair of the electrical equipment; the ability to provide an up-to-date notification that the maintenance or repair has been completed; the ability to provide information to the electrical service technician such as a thermal image of the electrical equipment; the ability to provide electrical equipment data about the electrical equipment to the electrical service technician; the ability to provide a picture of the electrical equipment to the electrical service technician; the ability to provide a panel schedule of the electrical equipment to the electrical service technician; the ability to provide a floor plan related to the electrical equipment to the electrical service technician; and the ability to provide a work history of the electrical equipment to the electrical service technician. In fact, in many of the preferred embodiments, these advantages are optimized to an extent that is considerably higher than heretofore achieved in prior, known systems and methods for scheduling and performing maintenance and/or repair on electrical equipment.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIG. 1 illustrates one embodiment for a method for determining a priority of which piece of electrical equipment is going to get maintenance or repair, according to the present invention;

FIG. 2 is a graphical illustration of an interactive one-line diagram, according to the present invention;

FIG. 3 illustrates one embodiment for a method for performing maintenance or repair on a piece of electrical equipment, according to the present invention;

FIG. 4 is a schematic front view illustration of an electrical panel, according to the present invention;

FIG. 5 is a schematic illustration of thumbnail illustrations of various types of information related to the electrical panel as they would appear on a display of a user's portable computing device including the electrical equipment data, according to the present invention;

FIG. 6 is a schematic illustration of an electrical panel with the panel door opened and showing a picture of the front of the electrical panel with the door of the electrical panel being opened, according to the present invention;

FIG. 7 is a schematic illustration of an enlarged thumbnail illustration of the panel schedule, according to the present invention;

FIG. 8 is a schematic illustration of an enlarged thumbnail illustration of the floor plan, according to the present invention;

FIG. 9 is a schematic illustration of an enlarged thumbnail illustration of the work history, according to the present invention; and

FIG. 10 illustrates an embodiment of a special purpose computing system configured with the example systems and/or methods disclosed.

### DETAILED DESCRIPTION OF THE PREFERRED EMBODIMENTS OF THE INVENTION

In order to address the shortcomings of the prior, known systems and methods for scheduling and performing maintenance and/or repair on electrical equipment, it would be desirable to utilize a system and method that allows a building supervisor or owner and/or an electrical maintenance provider to schedule what electrical equipment will be maintained and/or repaired and when that maintenance and/or repair will be conducted. The present invention will then provide a system and method to allow the electrical maintenance provider to perform the maintenance and/or repair on the desired electrical equipment and provide immediate and up-to-date feedback to the system that the required maintenance and/or repair has been completed.

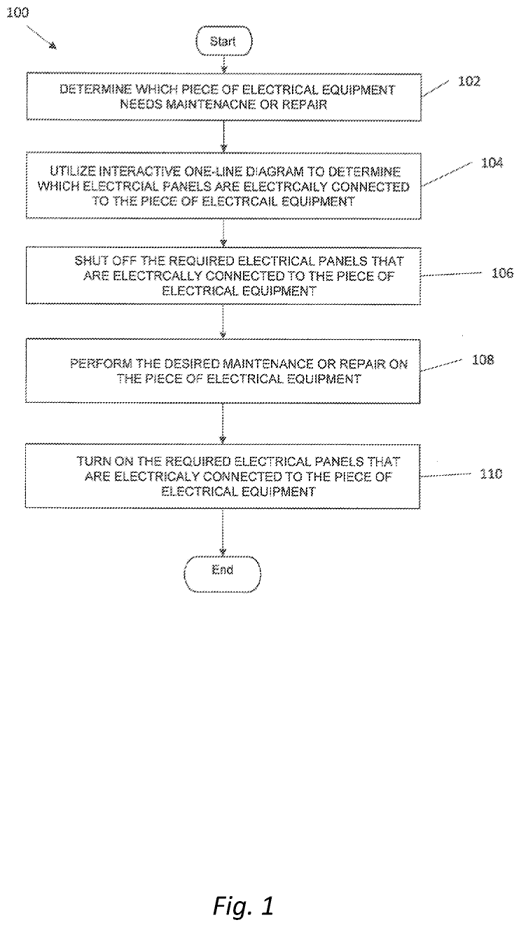

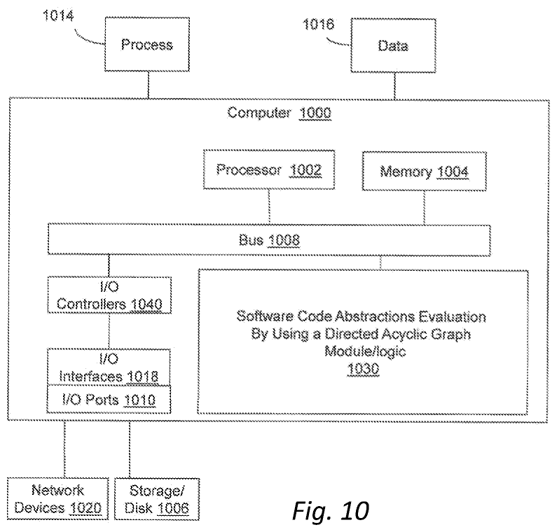

Referring now to FIG. 1, there is illustrated a method 100 for determining a priority of which piece of electrical equipment is going to get maintenance or repair. Portions of method 100 can be performed by at least a processor 1002 of a computer system (FIG. 10) that accesses and interacts with memories and/or data storage devices. For example, the processor 1002 at least accesses and reads/writes data to the memory and processes network communications to perform some of the actions of FIG. 1.

With continued reference to FIG. 1, at 102, the method 100 is initiated when a determination is made that a piece of electrical equipment needs maintenance or repair. It is to be understood that the determination can be made by an electrical service technician, a support staff personnel, a building owner or the like. Furthermore, the maintenance or repair notification can be provided through the computer 1000 (FIG. 10) as part of a routine maintenance schedule or repair schedule operating on the computer 1000. As discussed above, it is known that maintenance on electrical equipment can be scheduled at regular intervals such as annually. In this manner, the electrical maintenance provider can routinely schedule a time and date for the electrical maintenance provider to conduct the regularly scheduled maintenance. However, if the electrical equipment unexpectedly stops working, the electrical maintenance provider may have to adjust the electrical equipment maintenance schedule in order to repair the electrical equipment that has unexpectedly stopped working.

In 104, an interactive one-line diagram 200 associated with the piece of electrical equipment that needs maintenance or repair is accessed to determine which electrical panels and switchgear are electrically connected to the piece of electrical equipment, as will be discussed in greater detail later. It is to be understood that interactive one-line diagram 200 can be conventionally stored on disk 1006 and/or the memory 1004 (FIG. 10). A user can then conventionally access interactive one-line diagram 200 through computer 1000 and conventional input/output devices such as, for example, a mobile computing device such as a smartphone or a tablet, a keyboard, a microphone, a pointing and selection device, displays, network devices 1020, and so on (FIG. 10).

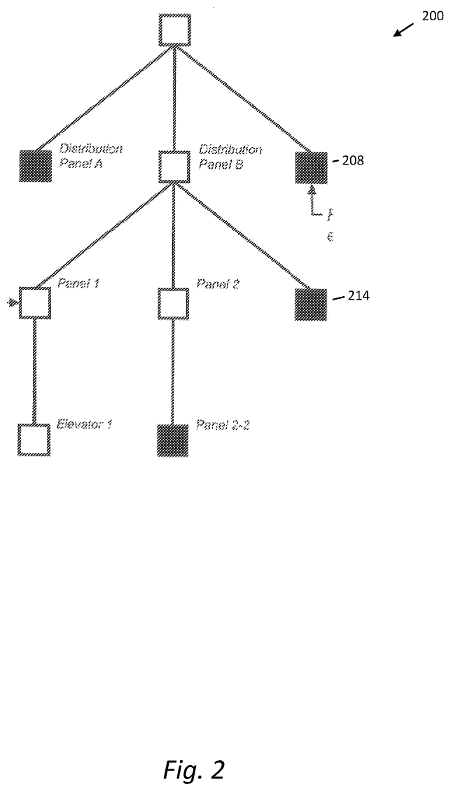

Referring now to FIG. 2, there is illustrated a schematic interactive one-line diagram 200. Assume that a piece of electrical equipment (such as sub-panel 218) in FIG. 2 needs to have a regularly scheduled maintenance performed on it. In this example, it could also be assumed that sub-panel 218 unexpectedly stopped working. In either case, work needs to be conducted on sub-panel 218 and it must be determined when the work can be completed on sub-panel 218.

As shown in FIG. 2, switch gear 202 is conventionally connected to an electrical source (not shown) that provides electricity to switchgear 202 and all of the other pieces of electrical equipment electrically connected to switchgear 202. As shown in FIG. 2, switchgear 202 is electrically connected to conventional electrical distribution panels 204, 206, and 208. Also, electrical distribution panel 206 is electrically connected to conventional electrical panels 210, 212, and 214. Furthermore, electrical panel 210 is electrically connected to elevator 216 and electrical panel 212 is electrically connected to electrical sub-panel 218.

If there are several work orders that need to be completed on various pieces of electrical equipment (such as elevator 216 and electrical sub-panel 218), it is important to understand how the pieces of electrical equipment are electrically connected to the switchgear 202, the electrical distribution panels 204-208, and the electrical panels 210-214. There are several considerations that must be taken into account before deciding which work order gets to be worked on first (work order prioritization).

First, the person assigning the priorities for the work orders must conventionally access and then look at the interactive one-line diagram 200 to determine which piece of electrical equipment needs to be maintained or repaired. In the above example, the sub-panel 218 needs to have regularly scheduled maintenance on it. The interactive one-line diagram 200 will then show what other pieces of electrical equipment are electrically connected to the sub-panel 218. In this example, electrical panel 212, electrical distribution panel 206, and switchgear 202 are all electrically connected to sub-panel 218.

Once it has been determined what other pieces of electrical equipment are electrically connected to the sub-panel 218, the electrical equipment directly connected to the sub-panel 218 and the next piece of electrical equipment located between the panel 212 and the switchgear 202 must also be turned off (shut off) to properly ensure that no electricity will flow into the sub-panel 218 while the maintenance and/or repair is being performed on the sub-panel 218. In this case, both the electrical panel 212 and electrical distribution panel 206 will have to be shut off.

However, as part of the analysis of which pieces of electrical equipment will need to be turned off, an analysis will also have to be made as to what affects will the shutting off the pieces of electrical equipment have on other pieces of equipment. In this example, if both electrical panel 212 and electrical distribution panel 206 must be turned off, then electrical panels 210 and 214 and electrical sub-panel 218 will also be without power. This is an important consideration since it must be determined that by shutting off electrical panels 210 and 214 and elevator 216, will that adversely affect the operation of any electrical equipment that is electrically connected to electrical panels 210 and 214 such as elevator 216. If it is determined that while the shutting off of distribution panel 206 is needed to conduct the maintenance and/or repair on sub-panel 218 and the shutting off of electrical panels 210 and 214 will not adversely affect the operation of any electrical equipment that is electrically connected to electrical panels 212 and 214, then the work order related to conducting the maintenance and/or repair on sub-panel 218 can be prioritized ahead of other work orders. However, if it is determined that the shutting off of electrical panel 210 will cause adverse harm to the elevator 216, for example, then the work order for the maintenance and/or repair of sub-panel 218 may have to be moved to a lower priority.

Assuming that the work order to perform the maintenance and/or repair on the sub-panel 218 has been scheduled as a high priority work order, returning back to FIG. 1, in 106, the electrical service technician then proceeds to locate the electrical distribution panel 206 and electrical panel 212 and shut off the electricity flow at electrical distribution panel 206 and electrical panel 212.

In 108, as will be discussed in greater detail later, the electrical service technician then performs the desired maintenance (or repair) on the sub-panel 218.

In 110, once the maintenance (or repair) has been completed on the sub-panel 218, the electrical service technician proceeds to locate the electrical distribution panel 206 and electrical panel 212 and turn on the electricity going into electrical distribution panel 206 and electrical panel 212. The electrical service technician can then proceed to sub-panel 218 to determine if the maintenance (or repair) on sub-panel 218 has been performed properly.

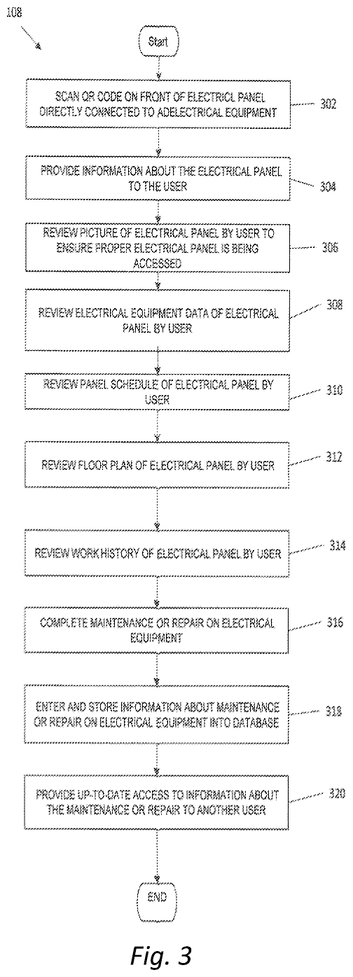

Regarding the step 108 (FIG. 1) of performing the maintenance (or repair) on sub-panel 218, referring now to FIG. 3, there is illustrated a method 300 for performing maintenance or repair on a piece of electrical equipment. Portions of method 300 can be performed by at least a processor 1002 of a computer system (FIG. 10) that accesses and interacts with memories and/or data storage devices. For example, the processor 1002 at least accesses and reads/writes data to the memory and processes network communications to perform some of the actions of FIG. 3.

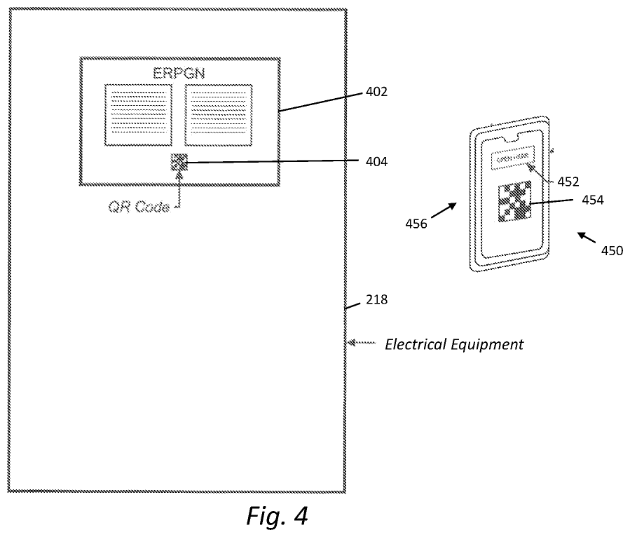

With continued reference to FIG. 3, at 302, the method 300 is initiated when the electrical service technician approaches a piece of electrical equipment that is being maintained or repaired and scans a conventional quick response code (QR code) 404 (FIG. 4) located on a panel door 402 of a piece of electrical equipment such as electrical sub-panel 218 (FIG. 2) using a conventional QR scanner 456 located on a conventional mobile communications device such as a smartphone or a tablet 450. As shown in FIG. 4, in particular, the electrical service technician touches the icon 452 on smartphone or a tablet 450 which enables the method 300 to proceed and allows the electrical service technician to scan the QR code 404 such that an image 454 of the QR code appears on the display 456 of the smartphone or a tablet 450.

Once the QR code 404 has been scanned and an image 454 of the QR code is shown on the display 456 of the smartphone or a tablet 450, the electrical service technician can then touch or otherwise interact with the image 454 in order to access various information about the piece of electrical equipment (such as electrical sub-panel 218) (FIG. 2).

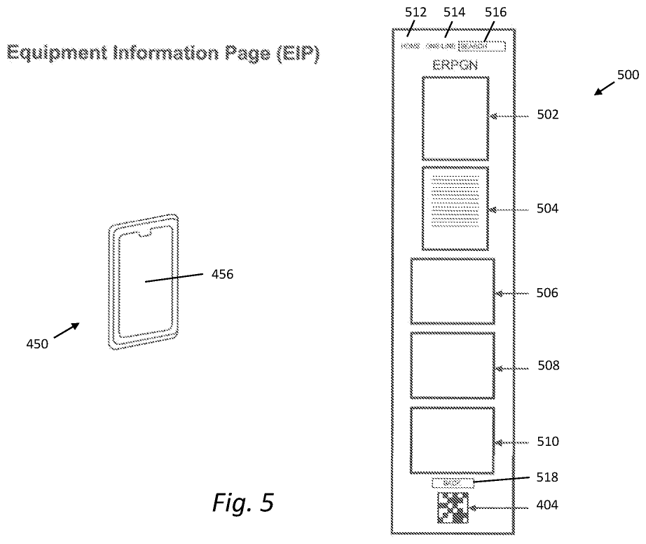

After the image 454 has been interacted with by the electrical service technician, various types of information can then be accessed by the electrical service technician. As shown in FIG. 5, thumbnail images 500 related to various information related to the piece of electrical equipment such as electrical sub-panel 218 can be displayed on the smartphone or table 450. For example, thumbnail 502 of a picture of the inside of the electrical sub-panel 218 can be shown. A thumbnail 504 of electrical equipment data related to the electrical sub-panel 218 can be shown. A thumbnail 506 of a panel schedule related to the electrical sub-panel 218 can be shown. A thumbnail 508 of a floor plan related to the electrical sub-panel 218 can be shown. Finally, a thumbnail 510 of a work history related to the electrical sub-panel 218 can be shown.

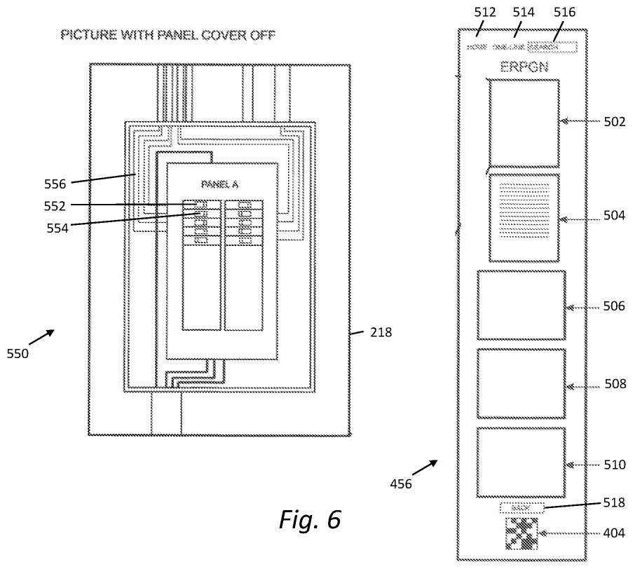

As further shown in FIGS. 5 and 6, the QR code 404 related to electrical sub-panel 218 can also be shown on the display 456 of the smartphone or table 450. Also, a home button 512 can be provided on the display 456 that will allow the user such as the electrical service technician to return the display to a home screen (not shown). Further, a one-line button 514 can be provided on the display 456 that will allow the user such as the electrical service technician to access the one-line diagram 200 (FIG. 2) associated with the piece of electrical equipment such as electrical sub-panel 218. Also, a search button 516 can be provided on the display 456 that will allow the user such as the electrical service technician to access the various thumbnail images 500, as shown in FIG. 5. Finally, a back button 518 can be provided on the display 456 that will allow the user such as the electrical service technician to go back to a previous search in order to review the results of that previous search.

With respect to the thumbnail 502 of a picture of the inside of the electrical panel 210, as shown in FIG. 6, the electrical service technician can then touch or otherwise interact with the image 502 in order to access a more detail picture 550 of what the inside of the piece of electrical equipment such as electrical sub-panel 218 looks like. In particular, the picture 550 will be displayed on the smartphone or table 450 and provide a picture the shows the location of various electrical components located within electrical sub-panel 218 such as circuit breakers 552, 554 and electrical wiring 556.

A unique aspect of the present invention is that the picture 550 along with the thumbnail images 502-510 provide an opportunity to allow the electrical service technician to ensure that the electrical sub-panel 218 that the electrical service technician is working on is actually the electrical panel that the electrical service technician should be working on. For example, the electrical service technician can check the picture 550 along with looking at the one-line diagram 200 (FIG. 2) by touching the one-button 514 to make sure that the electrical service technician needs to turn off electrical panel 212 in order to perform the maintenance on electrical sub-panel 218 (FIG. 2), as discussed earlier.

With respect to the thumbnail 504 of electrical equipment data of the electrical sub-panel 218, as shown in FIG. 6, the electrical service technician can then view the image 504 in order to view the electrical equipment data associated with the electrical sub-panel 218. It is to be understood that the image 504 can include various electrical equipment data information 505 related to the electrical sub-panel 218. For example, this information 505 can be related to panel name, location, panel model or any other information that may be of assistance to the electrical service technician. As discussed above, the information 505 can be used by the electrical service technician to ensure that the panel 212 is the electrical panel that is electrically connected to the electrical sub-panel 218 (FIG. 2), as discussed earlier.

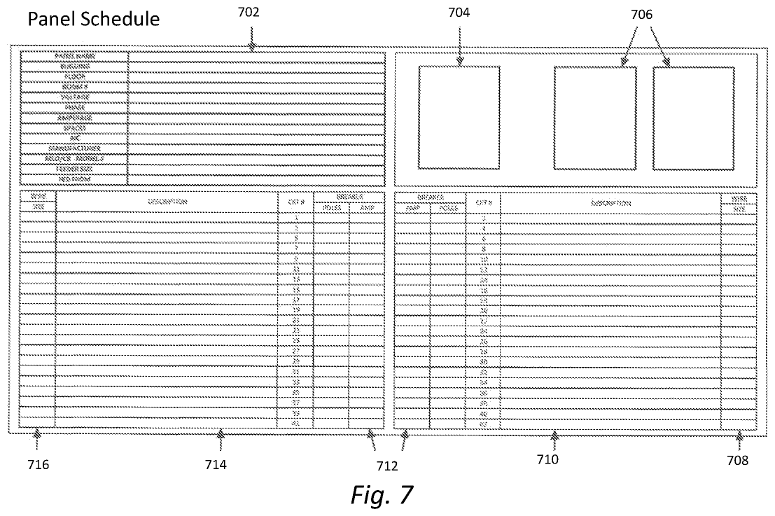

With respect to the thumbnail 506 of the panel schedule of the electrical panel 210, as shown in FIG. 7, the electrical service technician can then touch or otherwise interact with the image 506 in order to access the panel schedule 700 associated with the electrical sub-panel 218. It is to be understood that upon interacting with image 506, a copy of the panel schedule 700 will be displayed on smartphone or tablet 450, as discussed earlier. As can be seen in FIG. 7, the panel schedule 700 can include conventional information about the piece of electrical equipment such as electrical sub-panel 218 such as panel data 702, thermal images 704, images 706 of the electrical panel 218, wire size 708, circuit information 710, breaker information (amps and poles) 712, other circuit information 714, and other wire size information 716. As discussed above, the panel schedule 700 can be used by the electrical service technician to ensure that the panel 212 is the electrical panel that is electrically connected to the electrical sub-panel 218 (FIG. 2), as discussed earlier.

Another unique aspect of the present invention is the ability to provide thermal images 704 of the electrical sub-panel 218. As part of the maintenance and/or repair of the piece of electrical equipment such as electrical sub-panel 218, the electrical service technician can also conventionally take thermal pictures of the piece of electrical equipment using a conventional camera and thermal image application (not shown) stored on the smartphone or tablet 450. These thermal images 704 can be used to determine if there are hot spots on the piece of electrical equipment.

Typically, hot spots occur on a piece of electrical equipment when a circuit is being overloaded or otherwise not performing properly. It is common for an inexperienced electrical service technician to not detect a hot spot on a piece of electrical equipment. The thermal images 704 will show the electrical service technician where hot spots (circuit overloads) have been detected in the past on a piece of electrical equipment. Furthermore, once the maintenance and/or repair has been performed on the piece of electrical equipment, the electrical service technician can then take another thermal image 704 of the piece of electrical equipment and see if there are any other hot spots (circuit overloads) on the thermal image 704. It is to be understood that while only one (1) thermal image 704 is shown in FIG. 7, the electrical service technician will be able to access all of the thermal images 704 related to the piece of electrical equipment that have been conventionally stored on the disk 1006 and/or the memory 1004 (FIG. 10) by conventionally scrolling or otherwise reviewing the other thermal images 704.

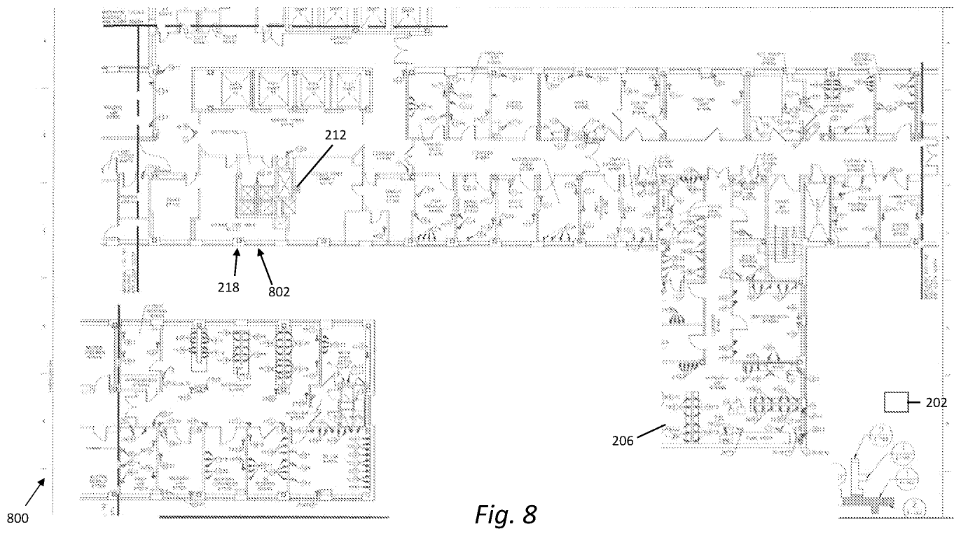

With respect to the thumbnail 508 of the floor plan related to electrical sub-panel 218, as shown in FIG. 8, the electrical service technician can then touch or otherwise interact with the image 508 in order to access the floor plan 800 associated with the electrical sub-panel 218. It is to be understood that upon interacting with image 508, a copy of the floor plan 800 will be displayed on smartphone or tablet 450, as discussed earlier. As can be seen in FIG. 8, the floor plan 800 can include conventional information about the locations of pieces of electrical equipment such as switchgear 202, electrical distribution panel 206, electrical panel 212, electrical sub-panel 218, and room 802 in which electrical sub-panel 218 is located. This information can be of particular interest to the electrical service technician if the electrical technician is not familiar with the location of the switchgear 202, electrical distribution panel 206, electrical panel 212, electrical sub-panel 218, and/or room 802. Furthermore, as discussed above, the floor plan 800 can be used by the electrical service technician to ensure that the panel 212 is the electrical panel that is electrically connected to the electrical sub-panel 218 (FIG. 2), as discussed earlier.

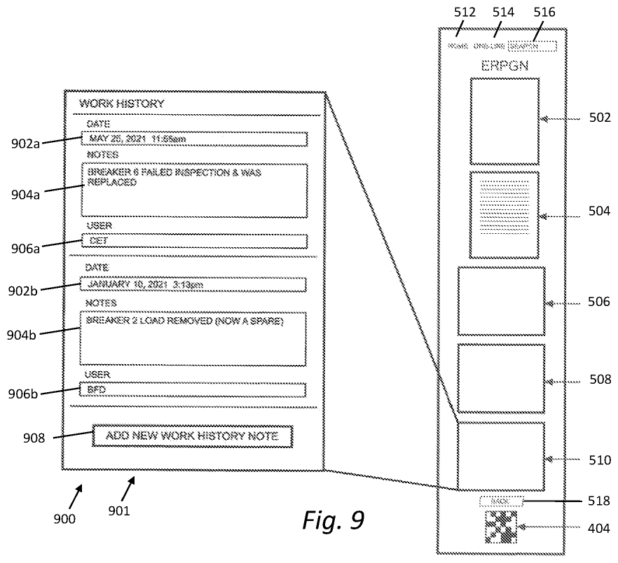

With respect to the thumbnail 510 of the work history related to electrical sub-panel 218, as shown in FIG. 9, the electrical service technician can then touch or otherwise interact with the image 510 in order to access the work history 900 associated with the electrical sub-panel 218. It is to be understood that upon interacting with image 510, an interactive work history screen 901 will be displayed on smartphone or tablet 450, as discussed earlier. As can be seen in FIG. 9, the work history screen 901 can include information related to the date 902a and 902b that the work was completed, notes 904a and 904b related to the work that was completed, a user section 906a and 906b that provides information related to the electrical service technician that performed the work on electrical sub-panel 218, and an add new work history note button 908 that will allow the electrical service technician to add information about the date, work notes and electrical service technician name for future work that is completed on the electrical sub-panel 218, as will be discussed in greater detail later. Again, as discussed above, the work history 900 can be used by the electrical service technician to ensure that the electrical sub-panel 218 is the piece of electrical equipment that needs to have the work completed on it (FIG. 2), as discussed earlier.

With continued reference back to FIG. 3 and reference to FIGS. 4-9, at 304, the method 300 continues with the electrical service technician being provided information about the piece of electrical equipment such as electrical sub-panel 218 after the electrical service technician scans the QR code (FIG. 4).

In 306, the electrical service technician can interact with image 502. As discussed above, with respect to the thumbnail 502 of a picture of the inside of the electrical sub-panel 218, as shown in FIG. 6, the electrical service technician can then touch or otherwise interact with the image 502 in order to access a more detail picture 550 of what the inside of the piece of electrical equipment such as electrical sub-panel 218 looks like. In particular, the picture 550 will be displayed on the smartphone or table 450 and provide a picture the shows the location of various electrical components located within electrical sub-panel 218 such as circuit breakers 552, 554 and electrical wiring 556. Finally, the electrical service technician can check the picture 550 along with looking at the one-line diagram 200 (FIG. 2) by touching the one-button 514 to make sure that the electrical service technician needs to turn off electrical panel 212 in order to perform the maintenance on electrical sub-panel 218 (FIG. 2), as discussed earlier.

In 308, as shown in FIGS. 5 and 6, the electrical service technician can then view the image 504 in order to view the electrical equipment data associated with the electrical sub-panel 218. It is to be understood that the image 504 can include various electrical equipment data information 505 related to the electrical sub-panel 218. For example, this information 505 can be related to panel name, location, panel model or any other information that may be of assistance to the electrical service technician. As discussed above, the information 505 can be used by the electrical service technician to ensure that the panel 212 is the electrical panel that is electrically connected to the electrical sub-panel 218 (FIG. 2), as discussed earlier.

In 310, as shown in FIG. 7, the electrical service technician can then touch or otherwise interact with the image 506 in order to access the panel schedule 700 associated with the electrical sub-panel 218. It is to be understood that upon interacting with image 506, a copy of the panel schedule 700 will be displayed on smartphone or tablet 450, as discussed earlier. As can be seen in FIG. 7, the panel schedule 700 can include conventional information about the piece of electrical equipment such as electrical sub-panel 218 such as panel data 702, thermal images 704, images 706 of the electrical panel 218, wire size 708, circuit information 710, breaker information (amps and poles) 712, other circuit information 714, and other wire size information 716. As discussed above, the panel schedule 700 can be used by the electrical service technician to ensure that the panel 212 is the electrical panel that is electrically connected to the electrical sub-panel 218 (FIG. 2), as discussed earlier.

In 312, as shown in FIG. 8, the electrical service technician can then touch or otherwise interact with the image 508 in order to access the floor plan 800 associated with the electrical sub-panel 218. It is to be understood that upon interacting with image 508, a copy of the floor plan 800 will be displayed on smartphone or tablet 450, as discussed earlier. As can be seen in FIG. 8, the floor plan 800 can include conventional information about the locations of pieces of electrical equipment such as switchgear 202, electrical distribution panel 206, electrical panel 212, and electrical sub-panel 218. This information can be of particular interest to the electrical service technician if the electrical service technician is not familiar with the location of the switchgear 202, electrical distribution panel 206, electrical panel 212, and/or electrical sub-panel 218. Furthermore, as discussed above, the floor plan 800 can be used by the electrical service technician to ensure that the panel 212 is the electrical panel that electrically connected to the electrical sub-panel 218 (FIG. 2), as discussed earlier.

In 314, as shown in FIG. 9, the electrical service technician can then touch or otherwise interact with the image 510 in order to access the work history 900 associated with the electrical sub-panel 218. It is to be understood that upon interacting with image 510, an interactive work history screen 901 will be displayed on smartphone or tablet 450, as discussed earlier. As can be seen in FIG. 9, the work history screen 901 can include information related to the date 902a and 902b that the work was completed, notes 904a and 904b related to the work that was completed, a user section 906a and 906b that provides information related to the electrical service technician that performed the work on electrical sub-panel 218, and an add new work history note button 908 that will allow the electrical service technician to add new information about the date, work notes and technician name for future work that is completed on the electrical sub-panel 218, as will be discussed in greater detail later. Again, as discussed above, the work history 900 can be used by the electrical service technician to ensure that the electrical sub-panel 218 is the piece of electrical equipment that needs to have the work completed on it (FIG. 2), as discussed earlier.

In 316, the electrical service technician has completed the work on the electrical sub-panel 218.

In 318, as discussed above, the electrical service technician can interact with the add new work history note button 908 (FIG. 9) that will allow the electrical service technician to add information about the date, work notes and technician name for work that is completed on the electrical sub-panel 218. As shown in FIG. 9, on May 25, 2021 (date section 902a), as part of the maintenance to electrical sub-panel 218, electrical technician CET (user section 906a) noted that breaker 6 failed inspection and was replaced (notes section 904a).

In 320, another unique aspect of the present invention is the use of interactive work history screen 901 that allows the electrical service technician to immediately enter information into computer 1000 (FIG. 10) regarding the maintenance or repairs that have been completed on the piece of electrical equipment such as electrical sub-panel 218. In particular, the electrical service technician touches or otherwise interacts with add new work history note button 908. A new date section 902a, notes section 904, and a user section 906a will be displayed to the electrical service technician. The electrical service technician can then user his/her smartphone or tablet 450 to enter the date that the work order was completed (May 25, 2021) into date section 902a. The electrical service technician can then enter a brief description of the work completed on the electrical sub-panel 218 (breaker 6 failed inspection and was replaced) into notes section 902a. Finally, the electrical service technician can enter the initials of the electrical service technician (CET) into the user section 906a. In this manner, immediate and up-to-date information related to the work history of the electrical sub-panel 218 can be conventionally uploaded to the system so that the building supervisor or owner and/or an electrical maintenance provider have access to this information.

Computing Device Embodiment

FIG. 10 illustrates an example special purpose computing device that is configured and/or programmed with one or more of the example systems and methods described herein, and/or equivalents. The example computing device may be a computer 600 that includes a processor 1002, a memory 1004, and input/output ports 1010 operably connected by a bus 1008. In one example, the computer 1000 may include a scheduling and performing maintenance or repair module/logic 1030 configured to provide scheduling and performing maintenance or repair on pieces of electrical equipment, as performed by the method of FIGS. 1 and 3. In different examples, the logic 1030 may be implemented in hardware, a non-transitory computer-readable medium with stored instructions, firmware, and/or combinations thereof. While the logic 1030 is illustrated as a hardware component attached to the bus 1008, it is to be appreciated that in other embodiments, the logic 1030 could be implemented in the processor 1002, stored in memory 1004, or stored in disk 1006.

In one embodiment, logic 1030 or the computer is a means (e.g., structure: hardware, non-transitory computer-readable medium, firmware) for performing the actions described. In some embodiments, the computing device may be a special purpose server operating in a Cloud computing system, a server configured in a Software as a Service (SaaS) architecture, a smart phone, laptop, tablet computing device, and so on.

Describing an example configuration of the computer 1000, the processor 1002 may be a variety of various specially programmed processors including dual microprocessor and other multi-processor architectures. A memory 1004 may include volatile memory and/or non-volatile memory. Non-volatile memory may include, for example, ROM, PROM, and so on. Volatile memory may include, for example, RAM, SRAM, DRAM, and so on.

A storage disk 1006 may be operably connected to the computer 1000 via, for example, an I/O controller 1040, an input/output (I/O) interface (e.g., card, device) 1018 and an input/output port 1010. The disk 1006 may be, for example, a magnetic disk drive, a solid-state disk drive, a floppy disk drive, a tape drive, a Zip drive, a flash memory card, a memory stick, and so on. Furthermore, the disk 1006 may be a CD-ROM drive, a CD-R drive, a CD-RW drive, a DVD ROM, and so on. The memory 1004 can store a process 1014 and/or a data 1016, for example. The disk 1006 and/or the memory 1004 can store an operating system that controls and allocates resources of the computer 1000.

The computer 1000 may interact with input/output (I/O) devices via the I/O controller 1040, the I/O interfaces 1018, and the input/output ports 1010. Input/output devices may be, for example, a keyboard, a microphone, a pointing and selection device, cameras, video cards, displays, the disk 1006, the network devices 1020, and so on. The input/output ports 1010 may include, for example, serial ports, parallel ports, and USB ports.

The computer 1000 can operate in a network environment and thus may be connected to the network devices 1020 via the I/O controller 1040, the I/O interfaces 1018, and/or the I/O ports 1010. Through the network devices 1020, the computer 1000 may interact with a network. Through the network, the computer 1000 may be logically connected to remote computers. Networks with which the computer 1000 may interact include, but are not limited to, a LAN, a WAN, and other networks.

### DEFINITIONS AND OTHER EMBODIMENTS

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a Cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101. It is inconsistent with the present disclosure to interpret that any of the functions performed and/or claimed herein can be performed in the human mind or manually.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor specially programmed with an algorithm for performing the disclosed methods, discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety.

The applicant reserves the right to physically incorporate into this specification any and all materials and information from any such patents, publications, scientific articles, web sites, electronically available information, and other referenced materials or documents to the extent such incorporated materials and information are not inconsistent with the description herein.

The written description portion of this patent includes all claims. Furthermore, all claims, including all original claims as well as all claims from any and all priority documents, are hereby incorporated by reference in their entirety into the written description portion of the specification, and Applicant reserves the right to physically incorporate into the written description or any other portion of the application, any and all such claims. Thus, for example, under no circumstances may the patent be interpreted as allegedly not providing a written description for a claim on the assertion that the precise wording of the claim is not specifically set forth in the written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps and are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended and those skilled in the art will recognize, that the invention embraces and is also thereby described in terms of any individual member or subgroup of members of the Markush group.

Other embodiments are within the following claims. Therefore, the patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

Other modifications and implementations will occur to those skilled in the art without departing from the spirit and the scope of the invention as claimed. Accordingly, the description herein above is not intended to limit the invention, except as indicated in the appended claims.

Therefore, provided herein is a new and improved system and method for scheduling and performing maintenance and/or repair on electrical equipment. The preferred system and method for scheduling and performing maintenance and/or repair on electrical equipment, according to various embodiments of the present invention, offers the following advantages: ease of use; decreased time to schedule maintenance or repair of the electrical equipment; decreased time to perform the maintenance or repair of the electrical equipment; the ability to provide an up-to-date notification that the maintenance or repair has been completed; the ability to provide information to the electrical service technician such as a thermal image of the electrical equipment; the ability to provide electrical equipment data about the electrical equipment to the electrical service technician; the ability to provide a picture of the electrical equipment to the electrical service technician; the ability to provide a panel schedule of the electrical equipment to the electrical service technician; the ability to provide a floor plan related to the electrical equipment to the electrical service technician; and the ability to provide a work history of the electrical equipment to the electrical service technician.

In fact, in many of the preferred embodiments, these advantages of ease of use, decreased time to schedule maintenance or repair of the electrical equipment, decreased time to perform the maintenance or repair of the electrical equipment, the ability to provide an up-to-date notification that the maintenance or repair has been completed, the ability to provide information to the electrical service technician such as a thermal image of the electrical equipment, the ability to provide electrical equipment data about the electrical equipment to the electrical service technician, the ability to provide a picture of the electrical equipment to the electrical service technician, the ability to provide a panel schedule of the electrical equipment to the electrical service technician, the ability to provide a floor plan related to the electrical equipment to the electrical service technician, and the ability to provide a work history of the electrical equipment to the electrical service technician are optimized to an extent that is considerably higher than heretofore achieved in prior, known methods for scheduling and performing maintenance and/or repair on electrical equipment.

I claim:

1. A method for scheduling and performing maintenance and/or repair on electrical equipment, comprising:
determining that a piece of electrical equipment needs maintenance or repair;
accessing an interactive one-line diagram to determine if any other pieces of electrical equipment are electrically connected to the piece of equipment;
determining a priority for performing the maintenance or repair on the piece of electrical equipment;
shutting off a flow of electricity to at least one of the other pieces of electrical equipment that is electrically connected to the piece of electrical equipment;
accessing a plurality of thumbnail images related to the piece of electrical equipment;
performing the maintenance or repair on the piece of electrical equipment;
turning on the flow of electricity to at least the one of the other pieces of electrical equipment that is electrically connected to the piece of electrical equipment;
entering information about the maintenance or repair into a database; and
providing up-to-date access to the information about the maintenance or repair.

2. The method for scheduling and performing maintenance and/or repair on electrical equipment, according to claim 1, wherein the accessing an interactive one-line diagram to determine if any other pieces of electrical equipment are electrically connected to the piece of equipment, further comprises:
determining electrical connections between the piece of electrical equipment and any of the other pieces of electrical equipment;
preparing the interactive one-line diagram of the electrical connections, wherein the interactive one-line diagram shows how the piece of electrical equipment and any of the other pieces of electrical equipment are electrically connected; and
storing the interactive one-line diagram in the database.

3. The method for scheduling and performing maintenance and/or repair on electrical equipment, according to claim 1, wherein accessing a plurality of thumbnail images related to the piece of electrical equipment further comprises:
providing a plurality of images related to the piece of electrical equipment, wherein the plurality of images further comprises;
an image of a picture of the piece of electrical equipment;
an image of electrical equipment data related to the piece of electrical equipment;
an image of a panel schedule related to the piece of electrical equipment;
an image of a floor plan related to the piece of electrical equipment; and
an image of a work history related to the piece of electrical equipment.

4. The method for scheduling and performing maintenance and/or repair on electrical equipment, according to claim 3, wherein the accessing a plurality of thumbnail images related to the piece of electrical equipment further comprises:
providing a QR code on the piece of equipment; and
scanning the QR code to access the plurality of thumbnail images related to the piece of electrical equipment.

5. The method for scheduling and performing maintenance and/or repair on electrical equipment, according to claim 4, wherein the accessing a plurality of thumbnail images related to the piece of electrical equipment further comprises:
providing a user interface having a display;
upon scanning the QR code, providing the plurality of thumbnail images related to the piece of electrical equipment on the display; and
upon interacting with at least one of the plurality of thumbnail images, displaying at least one of the plurality of images.

6. The method for scheduling and performing maintenance and/or repair on electrical equipment, according to claim 3, wherein enter information about the maintenance or repair into a database further comprises:
providing a user interface having a display;
upon completing the maintenance or repair on the piece of electrical equipment, accessing the image of a work history on the display;
entering information related to the date of the maintenance or repair on the piece of electrical equipment through the user interface;
entering information related to a description of the maintenance or repair on the piece of electrical equipment through the user interface;
entering information related to an identification of an electrical service technician who performed the maintenance or repair on the piece of electrical equipment through the user interface; and
storing the information related to the date of the maintenance or repair on the piece of electrical equipment, the description of the maintenance or repair on the piece of electrical equipment, and the identification of an electrical service technician who performed the maintenance or repair on the piece of electrical equipment in the database.

7. The method for scheduling and performing maintenance and/or repair on electrical equipment, according to claim 3, wherein the method further comprises:
providing a user interface having a display, wherein the user interface further comprises:
a home button;
a one-line button;
a search button; and
a back button.

8. A non-transitory computer-readable medium storing computer-executable instructions that when executed by at least a processor of a computer cause the computer to:
determine that a piece of electrical equipment needs maintenance or repair;
access an interactive one-line diagram to determine if any other pieces of electrical equipment are electrically connected to the piece of equipment;
determine a priority for performing the maintenance or repair on the piece of electrical equipment;
shut off a flow of electricity to at least one of the other pieces of electrical equipment that is electrically connected to the piece of electrical equipment;
access a plurality of thumbnail images related to the piece of electrical equipment;
perform the maintenance or repair on the piece of electrical equipment;
turn on the flow of electricity to the at least one of the other pieces of electrical equipment that is electrically connected to the piece of electrical equipment;
enter information about the maintenance or repair into a database; and
provide up-to-date access to the information about the maintenance or repair.

9. The non-transitory computer-readable medium, according to claim 8, wherein the access an interactive one-line diagram to determine if any other pieces of electrical equipment are electrically connected to the piece of equipment, further comprises:
determine electrical connections between the piece of electrical equipment and any of the other pieces of electrical equipment;
prepare the interactive one-line diagram of the electrical connections, wherein the interactive one-line diagram shows how the piece of electrical equipment and any of the other pieces of electrical equipment are electrically connected; and
store the interactive one-line diagram in the database.

10. The non-transitory computer-readable medium, according to claim 8, wherein access a plurality of thumbnail images related to the piece of electrical equipment further comprises:
provide a plurality of images related to the piece of electrical equipment, wherein the plurality of images further comprises;
an image of a picture of the piece of electrical equipment;
an image of electrical equipment data related to the piece of electrical equipment;
an image of a panel schedule related to the piece of electrical equipment;
an image of a floor plan related to the piece of electrical equipment; and
an image of a work history related to the piece of electrical equipment.

11. The non-transitory computer-readable medium, according to claim 10, wherein the access a plurality of thumbnail images related to the piece of electrical equipment further comprises:
providing a QR code on the piece of equipment; and
scanning the QR code to access the plurality of thumbnail images related to the piece of electrical equipment.

12. The non-transitory computer-readable medium, according to claim 11, wherein the access a plurality of thumbnail images related to the piece of electrical equipment further comprises:
provide a user interface having a display;
upon scanning the QR code, provide the plurality of thumbnail images related to the piece of electrical equipment on the display; and
upon interacting with at least one of the plurality of thumbnail images, display at least one of the plurality of images.

13. The non-transitory computer-readable medium, according to claim 10, wherein enter information about the maintenance or repair into a database further comprises:
provide a user interface having a display;
upon completing the maintenance or repair on the piece of electrical equipment, access the image of a work history on the display;
enter information, by a user, related to the date of the maintenance or repair on the piece of electrical equipment through the user interface;
entering information, by a user, related to a description of the maintenance or repair on the piece of electrical equipment through the user interface;
entering information, by a user, related to an identification of an electrical service technician who performed the maintenance or repair on the piece of electrical equipment through the user interface; and
store the information related to the date of the maintenance or repair on the piece of electrical equipment, the description of the maintenance or repair on the piece of electrical equipment, and the identification of an electrical service technician who performed the maintenance or repair on the piece of electrical equipment in the database.

14. The non-transitory computer-readable medium, according to claim 10, wherein the method further comprises:
provide a user interface having a display, wherein the user interface further comprises:
a home button;
a one-line button;
a search button; and
a back button.

15. A system for scheduling and performing maintenance and/or repair on electrical equipment, comprising:
a user interface having a display;
at least one processor connected to at least one memory operably connected to the user interface and including instructions that when executed by at least the processor cause the processor to:
determine that a piece of electrical equipment needs maintenance or repair;
access an interactive one-line diagram to determine if any other pieces of electrical equipment are electrically connected to the piece of equipment;
determine a priority for performing the maintenance or repair on the piece of electrical equipment;
shut off a flow of electricity to at least one of the other pieces of electrical equipment that is electrically connected to the piece of electrical equipment;
access a plurality of thumbnail images related to the piece of electrical equipment;
perform the maintenance or repair on the piece of electrical equipment;
turn on the flow of electricity to at least one of the other pieces of electrical equipment that is electrically connected to the piece of electrical equipment;
enter information about the maintenance or repair into a database; and
provide up-to-date access to the information about the maintenance or repair.

16. The system for scheduling and performing maintenance and/or repair on electrical equipment, according to claim 15, wherein the access an interactive one-line diagram to determine if any other pieces of electrical equipment are electrically connected to the piece of equipment, further comprises:
determine electrical connections between the piece of electrical equipment and any of the other pieces of electrical equipment;
prepare the interactive one-line diagram of the electrical connections, wherein the interactive one-line diagram shows how the piece of electrical equipment and any of the other pieces of electrical equipment are electrically connected; and
store the interactive one-line diagram in the database.

17. The system for scheduling and performing maintenance and/or repair on electrical equipment, according to claim 15, wherein access a plurality of thumbnail images related to the piece of electrical equipment further comprises:
provide a plurality of images related to the piece of electrical equipment, wherein the plurality of images further comprises;
an image of a picture of the piece of electrical equipment;
an image of electrical equipment data related to the piece of electrical equipment;
an image of a panel schedule related to the piece of electrical equipment;
an image of a floor plan related to the piece of electrical equipment; and
an image of a work history related to the piece of electrical equipment.

18. The system for scheduling and performing maintenance and/or repair on electrical equipment, according to claim 17, wherein the access a plurality of thumbnail images related to the piece of electrical equipment further comprises:
providing a QR code on the piece of equipment; and
scanning, by the user interface, the QR code to access the plurality of thumbnail images related to the piece of electrical equipment.

19. The system for scheduling and performing maintenance and/or repair on electrical equipment, according to claim 18, wherein the access a plurality of thumbnail images related to the piece of electrical equipment further comprises:
upon scanning the QR code, provide the plurality of thumbnail images related to the piece of electrical equipment on the display; and
upon interacting with at least one of the plurality of thumbnail images, display at least one of the plurality of images on the user interface.

20. The system for scheduling and performing maintenance and/or repair on electrical equipment, according to claim 17, wherein enter information about the maintenance or repair into a database further comprises:
upon completing the maintenance or repair on the piece of electrical equipment, access the image of a work history on the display;
enter information, by a user, related to the date of the maintenance or repair on the piece of electrical equipment through the user interface;
entering information, by a user, related to a description of the maintenance or repair on the piece of electrical equipment through the user interface;
entering information, by a user, related to an identification of an electrical service technician who performed the maintenance or repair on the piece of electrical equipment through the user interface; and
store the information related to the date of the maintenance or repair on the piece of electrical equipment, the description of the maintenance or repair on the piece of electrical equipment, and the identification of an electrical service technician who performed the maintenance or repair on the piece of electrical equipment in the database.
